(19) United States
(12) Patent Application Publication
(10) Pub. No.: US 2026/0164362 A1
(43) Pub. Date: Jun. 11, 2026

(54) Power Outage-based Incident Report Triage and Remediation

(71) Applicant: T-Mobile Innovations LLC, Overland Park, KS (US)

(72) Inventors: Jose GONZALEZ, Maitland, FL (US); Dat HO, Orlando, FL (US); Brian LUSHEAR, Winter Springs, FL (US); Chris POIRIER, Titusville, FL (US); Todd SZYMANSKI, Winter Park, FL (US)

(21) Appl. No.: 18/976,308

(22) Filed: Dec. 10, 2024

(51) Int. Cl. H04W 52/02; H04W 24/10; H04W 64/00

(52) U.S. Cl. CPC H04W 52/0296; H04W 24/10; H04W 64/003

(57) ABSTRACT

A method comprises determining, by an incident management application executing on a computer system, whether a location of a cell site indicated in an incident report is in a location area of a grid power outage, obtaining, by the incident management application, an estimated restoration time of the grid power outage at the cell site from a power monitoring system, storing, by the incident management application, the incident report at a data store to hold the incident report for a period of time based on the estimated restoration time, and after the period of time, executing, by the incident management application, a remediation action for the cell site according to a rule based on at least one of equipment data describing radio and power equipment at the cell site, priority data associated with the cell site, or power equipment availability data.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Communication network operators build systems and tools to monitor their networks, to identify network elements (NEs) that need maintenance, to assign maintenance tasks to personnel, and to fix NEs. Operational support systems (OSSs) may be provided by vendors of NEs to monitor and maintain their products. When trouble occurs in NEs, the OSS and/or the NEs may generate an alarm notification. An incident reporting system may be provided to track incident reports which may be assigned to employees to resolve one or more pending alarms. A network operation center (NOC) may provide a variety of workstations and tools for NOC personnel to monitor alarms, close incident reports, and maintain the network as a whole. It is understood that operating and maintaining a nationwide communication network comprising tens of thousands of cell sites and other NEs is very complicated.

### SUMMARY

In an embodiment, a method for power outage-based incident report triage and remediation is disclosed. The method comprises identifying, by an incident management application executing on a computer system, an incident report indicating an alarm associated with a potential power incident based on a first rule indicating pre-defined associations between alarms and grid power outages, and determining, by the incident management application, whether a location of a cell site indicated in the incident report is in a location area of grid power outage. The method further comprises obtaining, by the incident management application, an estimated restoration time of the grid power outage at the cell site from a power monitoring system, in which the estimated restoration time indicates an estimated amount of time before power is restored at the cell site, and storing, by the incident management application, the incident report at a data store to hold the incident report when the incident report is in the location area of the grid power outage. The method further comprises determining, by the incident management application, that the cell site has a backup power source based on power equipment data associated with the cell site, waiting, by the incident management application, a period of time based on an estimated capacity of the backup power source, the estimated restoration time, a priority associated with the cell site, and a customer impact of the grid power outage at the cell site, and after the period of time, instructing, by the incident management application, a remediation action at the cell site based on radio equipment data describing one or more radio equipment at the cell site. The remediation action comprises performing power mitigation across the one or more radio equipment at the cell site.

In another embodiment, a computer system is disclosed. The computer system includes a processor, and an incident management application stored in a non-transitory memory of the computer system. The incident management application, when executed by the processor, causes the incident management application to be configured to determine whether a location of a network element indicated in an incident report is in a location area of a grid power outage based on power outage data received from a power monitoring system, obtain an estimated restoration time of the grid power outage at the network element, in which the estimated restoration time indicates an estimated amount of time before power is restored at the network element, and store the incident report at a data store to hold the incident report. When the network element does not have power and does not have a backup power source, the incident management application is further configured to determine a period of time to wait based on the estimated restoration time, priority data associated with the network element, and customer impact data describing a customer impact of the grid power outage at the network element, and after the period of time, execute a remediation action for restoring power to the network element based on power equipment data associated with the network element. The remediation action includes transmitting an instruction to a maintenance technician or a network operation center operator to dispatch a backup power source to the network element.

In yet another embodiment, a method comprises determining, by an incident management application executing on a computer system, whether a location of a cell site indicated in an incident report is in a location area of a grid power outage, obtaining, by the incident management application, an estimated restoration time of the grid power outage at the cell site from a power monitoring system, in which the estimated restoration time indicates an estimated amount of time before power is restored at the cell site, storing, by the incident management application, the incident report at a data store to hold the incident report for a period of time based on the estimated restoration time, and after the period of time, executing, by the incident management application, a remediation action for the cell site according to a rule based on at least one of equipment data describing radio and power equipment at the cell site, priority data associated with the cell site, or power equipment availability data.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a communication network according to various embodiments of the disclosure.

FIG. 2 is a block diagram illustrating an example incident report generated in the communication network of FIG. 1 according to various embodiments of the disclosure.

FIG. 3 is a message sequence diagram illustrating a first method of power outage-based incident report triage and remediation in the communication network of FIG. 1 according to various embodiments of the disclosure.

FIG. 4 is message sequence diagram illustrating a second method of power outage-based incident report triage and remediation in the communication network of FIG. 1 according to various embodiments of the disclosure.

FIG. 5 is a diagram illustrating an example of power outage-based incident reports for cell sites in a radio access network (RAN) of the communication network of FIG. 1 according to various embodiments of the disclosure.

FIG. 6 is a flow chart of a first method according to an embodiment of the disclosure.

FIG. 7 is a flow chart of a second method according to an embodiment of the disclosure.

FIG. 8A and FIG. 8B are block diagrams of a 5G network according to an embodiment of the disclosure.

FIG. 9 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

A communications network may include one or more radio access networks (RANs), each including network elements (NEs) used to transport traffic between a source and destination. The NEs may include, for example, cell sites, routers, virtual private networks (VPNs), macro/micro cells, etc. The communication network may also include an incident management system, which may include, for example, one or more OSSs, central monitoring station(s), incident reporting applications, and/or incident management applications, that work together to monitor and resolve hardware and software incidents (e.g., failures and faults) that may occur at the NEs in the system. For example, different types of incidents may occur at each of the NEs, and the different types of incidents may trigger alarms that are forwarded to the OSSs, and then propagated to an incident reporting application. The incident reporting application may be responsible for programmatically or manually generating an incident report detailing the alarm that caused the incident. The incident reporting application may create the incident report based on an alarm and send the incident report to an incident management application in the system. The incident management application may be responsible for enhancing the incident report, triaging the incident report, initiating a remediation action for the incident, and/or ensuring that the incident report is sent to the proper entity for resolution.

For example, cell sites in a RAN may be susceptible to different types of incidents caused by hardware, software, and/or power failures at the cell site. Each type of failure may be caused by various types of incidents that may occur at a cell site. For example, a cell site may experience a power failure when the cell site loses grid power (also referred to herein as a “grid power outage”), when one or more components (e.g., rectifier) fails at the cell site, a breaker has tripped, one or more wires supplying power have been inadvertently disconnected, etc. Therefore, not all power failures are caused by a grid power outage, or a loss of commercial power at a cell site. Rather, some power failures may be caused by smaller-scale incidents that may indeed be remedied, for example, by a maintenance technician on site at the cell site. Nevertheless, when a power failure occurs at a cell site, the cell site may still be unreachable, regardless of whether the power failure is caused by a grid power outage or a more small-scale power failure (e.g., wire failure, component failure, etc.). Correspondingly, these power failures may trigger alarms at the cell sites, which may or may not indicate that the incident is power-related, but may indicate that the cell site has become unreachable or down.

The incident management system may not be programmed to distinguish between large-scale grid power failures and smaller-scale power failures, which may be technically problematic because each failure requires specific, distinct remediation actions to be taken to resolve the failure. That is, when an alarm is received that is indicative of a power failure (be it large-scale or small-scale), the incident reporting application may generate the incident report and the incident management application may automatically triage the incident report for resolution, without considering whether the power failure is caused by a grid power outage. This may be a significant distinction because while grid power outages may be resolved in short periods of time by a power company, the smaller-scale power failures may require physical or programmatic intervention for resolution.

Therefore in some cases, when the power failure is caused by a grid power outage, the incident management application may instruct remediation actions to be performed at the cell site (e.g., resets, restarts, etc.) or instruct NOC operators to dispatch maintenance technicians/field operators to the cell sites, only to realize that these actions are futile relative to a grid power outage (i.e., a reset/restart cannot fix grid power outages, and maintenance technicians/field operators also cannot fix grid power outages). In this way, the programming of the incident management system is largely inefficient and ineffective in dealing with alarms that are associated with power failures, particularly those that are associated with grid power outages. As mentioned above, the incident management system may consume a heavy load of processing and communication resources to evaluate the incident report and perform futile remediation actions unnecessarily based on a power failure at an NE. Therefore, the handling of alarms triggered by power failures at the incident management system gives rise to various technical problems related to resource inefficiencies at the system.

The present disclosure teaches a technical solution to the foregoing technical problem related to network operations and maintenance by implementing methods and systems for power outage-based incident report triage and remediation. In particular, the embodiments disclosed herein are directed to identifying alarms that are triggered by power failures, and then verifying whether the power incident (e.g., power failure) is caused by a grid power outage or not. When the power incident is caused by a grid power outage, the incident management application may perform a series of steps to optimize the processing of the incident report describing the grid power outage, to ensure that proper resources are allocated to the resolution of the power incident only when necessary based on various factors, as described herein. In this way, the embodiments disclosed herein intelligently process alarms and incident reports based on whether the underlying incident is caused by a grid power outage.

In an embodiment, the incident management system may store various types of data that may facilitate the power outage-based incident report triage and remediation methods disclosed herein. For example, the system may store RAN equipment data for each of the NEs in the RAN managed by the system, and the RAN equipment data may include location data describing a location of each NE, radio equipment data describing the different radio equipment and corresponding functionalities at each NE, power equipment data describing the power equipment and capabilities at each NE, priority data describing a priority of each NE and dependencies with other NEs, and customer impact data describing a customer impact of an outage at each NE at various times of the day/month/year.

When an alarm is received from an NE (e.g., cell site) in the RAN, the incident reporting application may generate an incident report based on the alarm and queue the incident report up for further processing. The incident management application may evaluate the incident report, further enhance the incident report with additional data if available, and then triage the incident report based on various factors to ultimately resolve the underlying incident that triggered the alarm.

In an embodiment, the incident management application may be programmed with one or more rules (e.g., logic or code), which instructs the incident management application to perform certain actions on an incident report based on various conditions indicated in the incident report. For example, an incident report may describe the triggering alarm, identify the NE(s) affected by the alarm, indicate a location of the NE(s), etc. A rule programmed at the incident management application may instruct the incident management application to evaluate the incident report, identify the alarm indicated in the incident report, and determine whether the alarm is associated with a power incident based on pre-defined associations between different types of alarms and different types of known power incidents. The rule itself may define the pre-defined associations between different types of alarms and different types of known power incidents. For example, the incident management system may maintain historical data describing prior alarms received by the system and corresponding to known power incidents that triggered the respective prior alarms. The incident management system may use this historical data (in conjunction with an artificial intelligence or machine learning model) to determine the pre-defined associations between different types of alarms and different types of known power incidents to create the rule. As an illustrative example, the pre-defined associations may indicate that power alarms and transport alarms, which are two types of alarms that may be triggered at NEs in the RAN, may be associated with power incidents based on the historical data. When the incident management application determines that the alarm indicated in a currently evaluated incident report is associated with a power incident, the incident management may perform a series of optimization operations to more intelligently and effectively monitor and resolve the power incident in a resource and cost-efficient manner.

First, the incident management application may communicate with a power monitoring system to determine whether the affected NE identified in the incident report is in a location affected by a grid power outage (as opposed to another type of outage or failure). For example, the power monitoring system may be a platform associated with the power company responsible for the grid power outage or with a third party that specializes in the detection and diagnosis of power outages. The incident management application may transmit a request to the power monitoring system, in which the request indicates the location of the affected NE (obtained from the incident report). The power monitoring system may search databases to determine whether the location of the affected NE is within a location area of a current grid power outage (e.g., the power monitoring system may maintain data regarding location areas of all current grid power outages, and may use this data to determine whether the affected NE is affected by one of the grid power outages). If so, the power monitoring system may obtain power outage data describing the grid power outage affecting the NE and transmit the power outage data to the incident management application. The power outage data may indicate the location area of the grid power outage and/or an estimated restoration time of the grid power outage (e.g., an amount of time before power is restored at the NE). The estimated restoration time may be when the power company estimates that the issues in the grid power system causing the grid power outage will be resolved. The power monitoring system may transmit the power outage data to the incident management application, and the incident management application may store the power outage data with an identifier of the NE at a data store accessible by the incident management system.

The incident management application may then hold the incident report for a period of time rather than immediately triaging the incident report for resolution. Holding the incident report may involve temporarily storing the incident report (and subsequent incident reports arriving from the same NE/related NEs based on the same or similar alarms) in a data store for a determined period of time. The determined period of time may be based on various factors, such as, for example, the estimated restoration time of the grid power outage, whether the NE has a backup power source, an estimated capacity of the backup power source (if available), a priority of the NE, a customer impact of the grid power outage at the NE, etc.

In some cases, the grid power outage may have an estimated restoration time that is reasonable in view of the priority of the NE and customer impact of the outage at the NE (e.g., less than one hour when the NE is independent and does not have a high customer impact). Therefore, the most resource and cost-efficient plan may be to wait the estimated restoration time for the power company to restore power to the NE. In many cases, the period of time in which the incident report is held in the data store (rather than triaged for processing and resolution) may be the entire duration of the estimated restoration time, based on the expectation that the grid power outage will shortly be restored. In these cases, the incident management application may periodically communicate with the power monitoring system during the estimated restoration time to determine whether there are any updates to the grid power outage (e.g., the power is estimated to be restored sooner than the estimated restoration time, the estimated restoration time has increased, or the power has indeed been restored). When the incident management application receives notice that the power has been restored and the grid power outage has been resolved, the incident management application may automatically close the held incident reports received from the NE based on the alarms associated with the power incident. To automatically close the incident report, the incident management application may clear the incident report and corresponding alarms from all data stores in the system.

However, in other cases, the period of time in which the incident report is held in the data store may be based on whether the NE includes a backup power source (e.g., battery/generator) or not. When the NE includes an available and operating back up power source (e.g., a battery or a generator) with at least a predefined threshold amount of power/energy, the period of time to hold the incident report may be based on a comparison between the estimated restoration time and an estimated capacity of the backup power source (e.g., an amount of time the NE is capable of operating before the backup power source is depleted of power). The estimated capacity of the backup power source may be received in a message from the NE (e.g., over a data channel unaffected by the outage), or may be based on telemetry data associated with the backup power source (e.g., historical rate of power depletion based on various metrics, such as, coverage area, number of customers serviced, functioning radio equipment, equipment manufacturer, etc.).

The incident management application may be programmed with rules including instructions (e.g., logic or code) to first determine when the estimated restoration time is greater than the estimated capacity of the backup power source. Based on this determination, the rules may include instructions for the incident management application to define the period of time for holding the incident report to be at least a predefined threshold amount of time less than the estimated capacity of the backup power source (e.g., the remaining battery life of a battery or the remaining fuel supply of a generator). For example, suppose the estimated restoration time received from the power monitoring system is 8 hours, but the estimated capacity of the backup power source is 4 hours. The rules may instruct the incident management application to hold the incident report for a period of time of 2 hours (e.g., the predefined threshold period of time (2 hours) less than the estimated capacity of the backup power source (4 hours)).

The rules may also instruct the incident management application to perform one or more remediation actions after the determined period of time of 2 hours based on the RAN equipment data stored at the system (e.g., the radio equipment data, priority data, and customer impact data). For example, when the power equipment data of the NE indicates that different radios are functioning at the NE (e.g., cell site), the remediation action may involve performing power mitigation across the radios by throttling services provided by less significant radio equipment, or turning off certain radios, while retaining the functionality of the more significant radio equipment, thereby reducing battery usage at the NE. Additionally or alternatively, the remediation action may involve dispatching/shipping a battery to the NE when the power equipment data of the NE indicates that the NE is capable to receive and use a battery and/or when the estimated capacity of the battery falls below a minimum threshold. Additionally or alternatively, the remediation action may involve dispatching/shipping a generator when the power equipment data of the NE indicates that the NE is capable of using a generator and/or sending fuel for a generator to the NE when the estimated capacity of the generator falls below a minimum threshold. In some cases, the remediation action may involve communicating with the power monitoring system to receive an updated estimated restoration time of the grid power outage.

In this situation when the NE includes the backup power source, the incident management application may obtain the incident report, obtain the power outage data and estimated restoration time, and then execute the rules to hold the incident report in the data store for the period of time. After the period of time expires, the incident management application may execute the rule to evaluate the data stored at the system to determine an optimal remediation action for the power failure, and then instruct the execution of the remediation action.

In contrast, when the NE does not include a backup power source with at least a minimum threshold amount of power/energy, the period of time to hold the incident report may be based on a predefined default period of time for the NE, or may be programmatically defined with rules based on various types of data maintained at the system (e.g., power equipment data indicating whether the NE is capable of using backup power sources, power equipment availability data indicating whether backup power sources are available to ship to the NE, priority data indicating whether the other NEs rely on the functionality of the NE, customer impact data indicating a customer impact due to the power failure at the NE, historical data indicating prior power restoration times for the NE, etc.). For example, when the NE does not include a backup power source with at least a predefined threshold amount of power/energy, but the NE is a high priority cell site (e.g., a hub cell site providing a backhaul communication link to one or more other cell sites via a (microwave) radio link), the period of time to hold the incident report may be minimal, since a remediation action to restore power to the cell site is critical for the functioning of other cell sites. As another example, when the NE does not include a backup power source with at least a predefined threshold amount of power/energy, and the customer impact of the power failure at the NE is low (e.g., due to customer impact, location of NE, time, etc.), the period of time to hold the incident report may be a longer duration, but in some cases, still less than the estimated restoration time. In this case, the power incident is not impacting customers, and therefore, it may be worthwhile to save the processing/communication resources and time of the NOC personnel to hold the incident report rather than attempt to restore power.

The rules may also be programmed to instruct the incident management application to determine whether the cell site can be ((is capable of being) remediated during the power outage. In this case, the rules may consider various parameters, such as if the cell site has a compatible generator plug installed, and site accessibility. The rules may be programmed to instruct the incident management application to, for certain predefined cell sites, notify the building or facility personnel in advance before entering the vicinity or building of the cell site, and may also have restricted hours for entry (and as such, be scheduled accordingly).

As described above, the rules may also be programmed to instruct the incident management application to perform one or more remediation actions after the determined period of time based on the data stored at the system. In this situation when the NE does not have a backup power source, the incident management application may obtain the incident report, obtain the power outage data and estimated restoration time, and then execute the rules to hold the incident report in the data store for the period of time. After the period of time expires, the incident management application may execute the rules to evaluate the data stored at the system to determine an optimal remediation action for the power failure, and then instruct the execution of the remediation action.

In some cases, the incident report may be enhanced to identify the root cause of the power incident, to ensure that the remediation actions are performed at the correct NEs. For example, the priority data may indicate connected NEs, hub-and-spoke NEs, etc., such that the priority data indicates a higher priority for NEs that provide functionalities to other NEs, and a lower priority for NEs that operate independently or only depend on other NEs. For example, suppose a grid power outage occurs in a location of a hub cell site, providing connectivity and functionalities to several spoke cell sites, but the location of the spoke cell sites are not in the location area of the grid power outage. Nevertheless, since the hub cell site has experienced a power outage, the spoke cell sites may also experience outages (e.g., transport failures giving rise to transport alarms) due to the loss of services from the hub cell site. In this case, the incident management application may identify incident reports created based on the alarms from the spoke cell sites, determine that the spoke cell sites in fact depend on the services provided by a hub cell site that is affected by a grid power outage, and add an identifier of the hub cell site to the incident reports created for the outages at the spoke cell sites. This way, the incident management application may hold the incident reports from the spoke cell sites as described (thereby saving resources by not processing these incident reports), even though the spoke cell sites are not actually experiencing a grid power outage.

In an embodiment, a large number of cell sites may report a “loss of commercial power” alarm at roughly the same time, but the power monitoring system may not report any known power outages. In this case, the incident management application may generate an incident report describing a large-scale event (LSE), indicating that no known power outage has been reporting, and trigger the NOC to call the power company to report the outage and the update the incident report with an estimated restoration time if available. Because many sites were impacted at the same times, the possibility of a site-specific power issue can almost immediately be ruled out.

Therefore, as mentioned above, the embodiments of power outage-based incident report triage and remediation disclosed herein significantly increase network capacity and reduce the load on the network. For example, by ultimately preventing the repetitive and futile processing of incident reports caused by grid power outages, the incident management system may conserve communication and processing resources. This in turn prevents the system from overloading and crashing unnecessarily based on the excessive alarms/incident reports created in response to grid power outages, thereby preventing customers from experiencing the effects of the crashing, such as, for example, dropped calls and access failures. In addition, the embodiments disclosed herein enable the automation of more accurate resolution plans, as opposed to merely processing the NE through a series of pre-determined automated steps for resolution. The embodiments disclosed herein also result in the savings of significant monetary costs by not having to dispatch operators to a cell site when nothing can be done about the power outage.

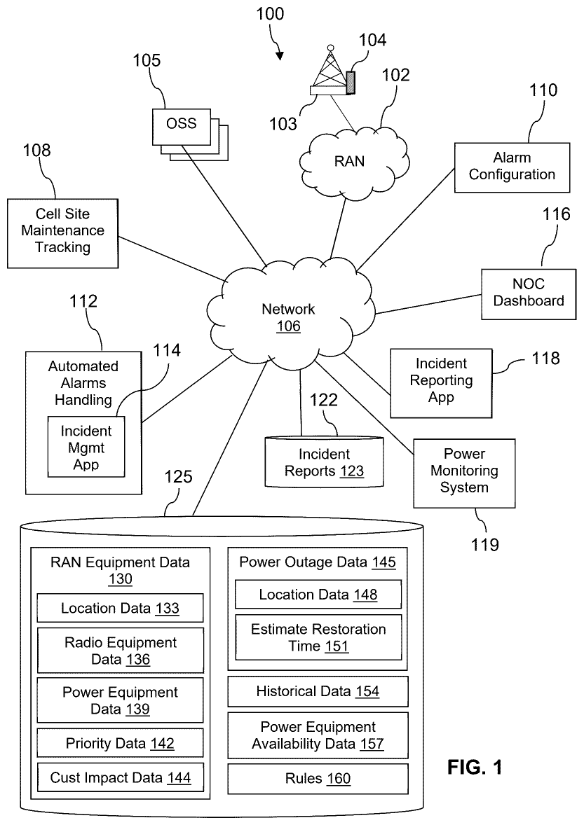

Turning now to FIG. 1, a communication network 100 is described. In an embodiment, the communication network 100 comprises a radio access network (RAN) 102, a plurality of operational support systems (OSSs) 105, a network 106, a cell site maintenance tracking system 108, an alarms configuration system 110, an automated alarms handling system 112 that executes an incident management application 114, a network operation center (NOC) dashboard system 116, an incident reporting application (or system) 118, a power monitoring system 119, and data stores 122 and 125. In an embodiment, communication network 100 may be a telecommunications carrier network comprising the RAN 102.

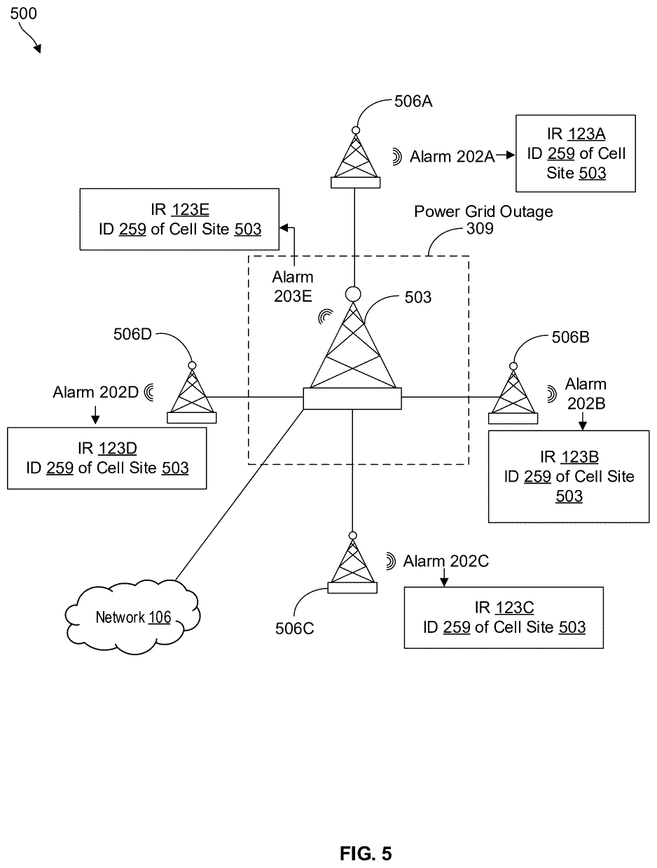

The RAN 102 comprises a plurality of NEs, such as, for example, cell sites 103 and backhaul equipment. In an embodiment, the RAN 102 comprises tens of thousands or even hundreds of thousands of cell sites 103. The cell sites 103 may comprise electronic equipment, radio equipment (e.g., antennas), grid power equipment (e.g., rectifiers, wires, power distribution panels, etc., used to receive power from the grid network), and backup power equipment (e.g., batteries, gas/diesel generators, etc. used to supply power). The cell sites 103 may be associated with towers or buildings on which the antennas may be mounted. The cell sites 103 may comprise a cell site router (CSR) that couples to a backhaul link from the cell sites to the network 106. The cell sites 103 may provide wireless links to user equipment (e.g., mobile phones, smart phones, personal digital assistants, laptop computers, tablet computers, notebook computers, wearable computers, headset computers) according to a 5G, a long-term evolution (LTE), code division multiple access (CDMA), or a global system for mobile communications (GSM) telecommunication protocol. As further described in FIG. 5, there may be different types of cell sites 103 in the RAN 102. For example, hub cell sites 103 may comprise central, larger-scale base stations that provide backhaul for multiple surrounding spoke cell sites 103, often using a microwave backhaul to connect these sites to the wider RAN 102. Spoke cell sites 103 may be peripheral base stations that connect to the central hub cell site 103, relying on it for backhaul and broader network access.

In an embodiment, the OSSs 105 comprises tens or even hundreds of OSSs. The network 106 comprises one or more public networks, one or more private networks, or a combination thereof. The RAN 102 may from some points of view be considered to be part of the network 106 but is illustrated separately in FIG. 1 to promote improved description of the network 100.

The cell site maintenance tracking system 108 is a system implemented by one or more computers. Computers are discussed further hereinafter. The cell site maintenance tracking system 108 is used to track maintenance activities on NEs (e.g., cell site equipment, routers, gateways, and other network equipment). When a NE is in maintenance, alarms that may occur on the NE may be suppressed, to avoid unnecessarily opening incident reports related to such alarms that may be generated because of unusual conditions the equipment may undergo pursuant to the maintenance activity. When a maintenance action is completed, maintenance personnel may be expected to check and clear all alarms pending on the subject NE before the end of the time scheduled for the maintenance activity.

The alarm configuration system 110 is a system implemented by one or more computers. The alarm configuration system 110 allows users to define logic and instructions for handling alarms, for example rules for automatic processing of alarms by the automated alarms handling system 112. The alarm configuration system 110 may define an alarm configuration rules for when an alarm leads to automatic generation of an incident report, as described herein.

Alarms are flowed up from NEs of the RAN 102 via the OSSs 105 to be stored in the data store 125. The NOC dashboard 116 can access the alarms stored in the data store 125 and provide a list of alarms on a display screen used by NOC personnel. NOC personnel can manually open incident reports on these alarms. In an embodiment, the NOC dashboard 116 provides a system that NOC personnel can use to monitor health of a carrier network (e.g., monitor the RAN 102 and at least portions of the network 106), to monitor alarms, to drill down to get more details on alarms and on NE status, to review incident reports, and to take corrective actions to restore NEs to normal operational status. The NOC dashboard 116 may interact with the data store 125, with the cell site maintenance tracking system 108, the OSSs 105, the RAN 102, and other systems. NOC personnel can use the NOC dashboard 116 to manually create incident reports based on alarms reviewed in a user interface of the NOC dashboard 116.

The incident reporting application (or system) 118 can monitor the alarms stored in the data store 125 and automatically generate incident reports 123 on these alarms based in part on the alarm configurations/logic/rules created and maintained by the alarms configuration system 110 (and store the incident reports in data store 122). For example, an alarm configuration rule defined by the alarm configuration system 110 may indicate that an incident report 123 is not to be created for a specific alarm until the alarm has been active for a predefined period of time, for example for five minutes, for ten minutes, for fifteen minutes, for twenty minutes, for twenty-five minutes, or some other period of time less than two hours. The time criteria for auto generation of incident reports 123 may be useful to avoid opening and tracking incidents that are automatically resolved by other components of the network 100, as described further hereinafter. Incident reports 123 may be referred to in some contexts or by other communication service providers as tickets or trouble tickets.

The incident management application 114 may operate upon incident reports 123 in a sequence of processes. In an embodiment, the incident management application 114 may perform automated triage on incident reports 123 that includes automated enrichment of alarms and/or incident reports 123, automated dispatch of instructions or communications to another system/entity, automated dispatch to field operations personnel for some incident reports, and automated testing. Automated enrichment may comprise looking-up relevant information from a plurality of disparate sources and attaching this relevant information to the incident report. The looked-up information may comprise local environmental information such as weather reports, rainfall amounts, temperature and wind. The looked-up information may comprise logs of recent maintenance activities at the affected NE.

The automated triage process may involve determining a probable root cause for the incident and adding this to the incident report during the enrichment action. The probable root causes may be categorized as related to electric power, backhaul (e.g., transport), maintenance, or equipment (e.g., hardware-related, software-related, power equipment-related), but within these general categories it is understood there may be a plurality of more precise probable root causes. The automated triage process can assign an incident report 123 to personnel for handling based on its determination of the probable root cause of the incident report.

In an embodiment, the incident management application 114 may automatically close an incident report 123 when NE status warrants such automated closure. Automated closure may happen because NOC personnel have taken manual corrective action to restore proper function of one or more NEs. Automated closure may happen because the incident management application 114 determines that the incident report 123 was created pursuant to a maintenance action that extended beyond the scheduled maintenance interval and that the scheduled maintenance interval was later extended, but extended after a related incident report had already been generated. The incident management application 114 may perform automated remediation of alarm conditions associated with incident reports 123.

In an embodiment, the incident management application 114 in the communication network 100 may be enhanced to perform the power outage-based incident report triage and remediation methods described herein. The alarm configuration system 110 may also be enhanced to add new rules 160 (e.g., instructions in the form of logic or code) related to the management of incident reports 123 created based on alarms signaling a power-related incident (also referred to herein as a “power failure” or “power incident”), as further described herein.

A power incident may occur in various scenarios. For example, a power incident may occur when the NE loses grid power from the grid network. The grid network refers to the electrical power grid, which may be a vast interconnected network that delivers electricity from producers (e.g., power plants) to consumers (e.g., the NEs in the RAN 102). An NE may lose power from the grid network and experience a grid power outage for various reasons, such as, for example, severe weather (storms, hurricanes, ice storms, etc. that can damage power lines, transformers, and other infrastructure, leading to widespread outage), equipment failure at the grid network (aging or faulty equipment (e.g., circuit breakers, transformers, power lines, etc.) causing localized or widespread power outages), natural disasters (earthquakes, floods, wildfires, etc. that can physically damage infrastructure), overload (high demand for electricity especially during peak usage times can overload the grid network, leading to outages), human error (accidental damage to power lines or mistakes made during maintenance and operation of the grid network can cause power interruptions, etc.).

However, in some cases, the power incidents are based on smaller-scale failures, such as local power equipment failures at the NE. For example, power incidents may occur based on rectifier failures or faulty wires at the NE. Nevertheless, as mentioned above, power incidents occurring at the NEs may result in connectivity issues (e.g., the NE being unreachable) and loss of functionality at the NE, both of which may trigger different types of alarms at the NE. For example, power incidents may trigger power alarms (e.g., indicating a loss of power at the NE), battery alarms (e.g., triggered when the NE switches to backup battery power, or may indicate low battery levels, battery discharge, or failure to charge properly), generator alarms (e.g., triggered when the NE switches to generator power, or may indicate generator startup failure, low fuel level, or operational problems), rectifier alarms (e.g., triggered when a failure at the rectifier is detected), environmental alarms (e.g., triggered when the NE detects temperature, humidity, or ventilation issues), transport alarms (e.g., triggered when the NE is unreachable or cannot communicate data), communication loss alarm (e.g., triggered when the NE loses a communication link), heartbeat alarm (e.g., triggered when loss of confirmation of heartbeat from an NE), etc.

Regardless of the type of power incident and corresponding triggered alarm, the incident reporting application 118 may generate the incident reports 123 for the power incidents based on the corresponding alarms, and queue up the incident reports 123 for triage by the incident management application 114. The incident management application 114 may be enhanced with rules 160 (stored at data store 125, as further described below) to identify the incident reports 123 related to grid power outages and temporarily hold (or store) the identified incident reports 123 in a data store 122 (e.g., one or more memories or a cache).

To this end, the incident management application 114 may communicate with the power monitoring system 119 to identify the incident reports 123 related to grid power outages. The power monitoring system 119 may be a computer system (with hardware and software resources) or platform associated with the power company responsible for the grid power outage or with a third party that specializes in the detection and diagnosis of power outages. The power monitoring system 119 may include a data store storing data describing all of the detected power outages monitored by the power monitoring system 119.

The data store 125 may store various types of data to facilitate the power-outage based incident report triage and remediation according to the embodiments disclosed herein. As shown in FIG. 1, the data store 125 may store RAN equipment data 130, power outage data 145, historical data 154, power equipment availability data 157, and the aforementioned rules 160. The RAN equipment data 130 may describe various attributes of each of the NEs in the RAN 102. The RAN equipment data 130 may include location data 133, radio equipment data 136, power equipment data 139, priority data 142, and customer impact data 144. The location data 133 may describe a location of each of the NEs in the RAN 102, and the location may be defined, for example, by GPS coordinates or a geohash value. The radio equipment data 136 may define the different types of antennas and other radio equipment at each of the NEs in the RAN 102, and the corresponding communication functionalities, capabilities, protocols, etc., related to the radio equipment (e.g., frequency spectrums, bandwidth, latency, etc.) for each of the NEs in the RAN 102. The power equipment 139 may define the different types of power equipment (e.g., rectifiers, wires, batteries, generators, etc.) and power equipment capabilities (e.g., whether an NE is equipped with the components for connecting to a generator and receiving power from the generator) for each of the NEs in the RAN 102. The priority data 142 may indicate a priority level and/or dependency of each of the NEs in the RAN 102 (e.g., whether the NE is a hub cell site and thus a higher priority, whether the NE serves a critical coverage area, whether the NE provides functionalities to other NEs, etc.). The customer impact data 144 may indicate a value describing a level of customer impact at various times when an outage occurs at each of the NEs (e.g., a value indicating a high level of customer impact during peak hours at an NE serving a large customer base, or a value indicating a low level of customer impact during non-peak hours at an NE serving a remote location). The customer impact data indicates the customer impact of the grid power outage at the network element based on at least one of a number of users receiving services provided by the network element during the grid power outage, a time of day of the grid power outage, or other related network elements associated with the network element.

The power outage data 145 may include data requested and received from power monitoring systems 119 pertaining to grid power outages occurring at NEs in the RAN 102. As shown in FIG. 1, the power outage data 145 may include location data 148 and estimated restoration times 151 for each grid power outage occurring in the RAN 102. The location data 148 may include a location area of a grid power outage, and the location area may be defined as GPS coordinates or GPS coordinate ranges, or as geohash values. A geohash is a value or a compact string representation of the location area, encoding latitude and longitude into a short alphanumeric sequence. The longer the geohash value (e.g., the more digits in the string), the more precisely a region associated with the geohash is identified. The estimated restoration time 151 may be an estimated time of (or an estimated amount of time until) an expected restoration of the grid power outage. The estimated restoration time 151 for a grid power outage may change over time, and updates to the estimated restoration time 151 may be received from the power monitoring system 119 over time upon request.

The historical data 154 may aggregate data related to grid power outages (including the power outage data 145, identification of directly affected NEs and indirectly affected NEs, time duration of outage compared to estimated restoration times of the outage, etc.). The historical data 154 may also aggregate data from the incident reports 123 created for these outages, the corresponding remediation actions taken in response to the incident reports, and whether the remediation actions were successful in resolving the outage or whether the only solution was to wait for the power company to restore power to the area.

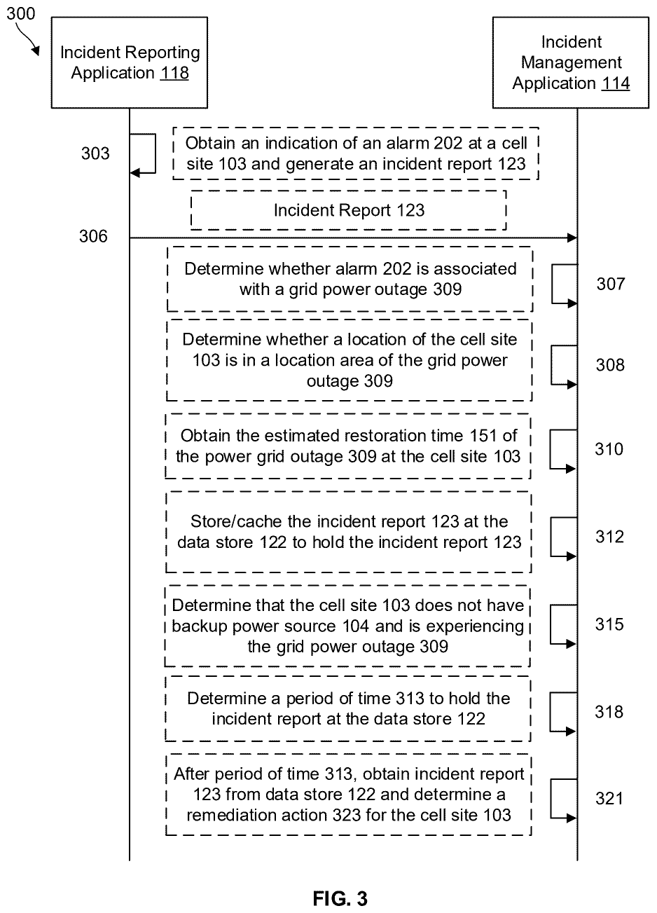

The rules 160 may refer to instructions (e.g., in the form of logic, code, and/or instructions) that may be programmed at the incident management application 114 (and the incident reporting application 118 in some cases) to perform the methods of power outage-based triage and remediation as disclosed herein. For example, the rules 160 may indicate predefined associations between different types of alarms indicated in incident reports 123 and whether the alarms are each likely to be associated with a grid power outage or not. The rules 160 may also instruct the incident management application 114 to perform predefined actions based on various conditions. For example, the various conditions that trigger the incident management application 114 may be based on a determination that an alarm indicated in an incident report 123 is pre-defined to be associated with a potential grid power outage, a determination that an NE affected by a grid power outage does or does not include a backup power source 104, a determination that an NE affected by a grid power outage provides services to other NEs that are not affected by grid power outages, a determination that the NE experiencing a grid power outage has a high customer impact level, a determination that the NE has different types of radio equipment that may be throttled/turned off for power conservation, etc.). The rules 160 may instruct the incident management application 114 to perform different actions based on the aforementioned conditions, and the actions may include, for example, adding data to the incident report 123, storing/holding the incident report 123 in the data store 122 for a determined period of time, determining the period of time to hold the incident report 123, pulling the held incident report 123 from storage, determining an optimal remediation action to perform at the NE based on the data in the incident report 123 and/or data stored in the data store 125, etc. Various examples of the incident management application 114 performing these actions based on the aforementioned conditions are further described below in FIGS. 3-5.

While FIG. 1 illustrates data store 122, which holds the incident reports 123 temporarily, as separate from data store 125 storing the data managed by the system, it should be appreciated that the incident reports 123 may also be held/stored temporarily at the data store 125. That is, the data stores 122 and 125 are illustrated as separate purely for discussion purposes, but the incident reports 123 may be held at any data store that is capable of temporarily storing and deleting incident reports 123, which is accessible by the incident reporting application 118 and the incident management application 115.

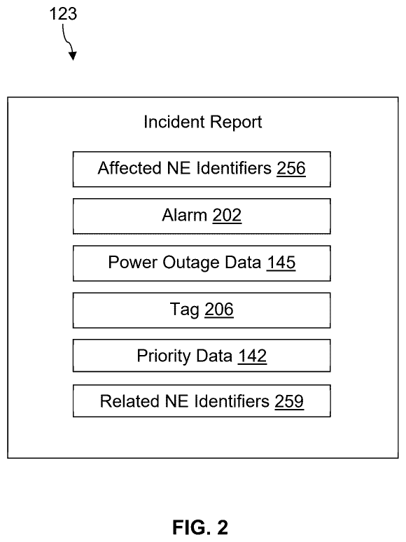

Referring now to FIG. 2, a diagram illustrating an example incident report 123 is described. The incident reporting application 118 may generate the incident report 123 based on an alarm (e.g., retrieved from the data store 125), in which the alarm triggered a power incident at an NE in the RAN 102, caused by a grid power outage. The incident reporting application 118 and/or the incident management application 114 may enhance the incident report 123 to include data associated with the determination that the power incident identified in the incident report 123 is triggered by a grid power outage.

The generated incident report 123 may include identifiers 256 of the one or more NEs affected by the power incident (e.g., when the determined grid power outage is in a location area of multiple cell sites 103 in the RAN 102, the incident report 123 may be created to indicate the power incident across each of the cell sites 103). The identifiers 256 of the NEs 156 may include an address or identifier of the NEs that are experiencing the power incident, or within the location area affected by the grid power outage. The generated incident report 123 may also include an identification of the alarm 202 (i.e., the current alarm) that was triggered at the NEs by the power incident (e.g., the alarm 202 may be transport alarms, power alarms, and/or any of the other types of alarms described above with reference to FIG. 1). The identification of the alarm 202 may include an identifier or value uniquely identifying the alarm (e.g., one value for a transport alarm, another value for a power alarm, etc.).

The incident report 123 may also include the power outage data 145 describing the power incident or grid power outage affecting the NEs, in which the power outage data 145 may include the location data 148 and/or the estimated restoration time 151 of the grid power outage. The incident report 123 may also include a tag 206 indicating that the incident report 123 describes a power incident specifically caused by a grid power outage (as opposed to a small-scale power-related incident or other type of incident). The tag 206 may be embodied in the incident report 123 in various different manners. For example, the tag 206 may be descriptive text added to the incident report 123, in which the descriptive text states that the power incident is a grid power outage. Alternatively or additionally, the tag 206 may be a single numerical value (of any number of digits) uniquely indicating that the power incident is a grid power outage (e.g., the value of 3 carried in the tag 206 may indicate that the power incident is a grid power outage). Alternatively or additionally, the tag 206 may be a bit set to 0 or 1, indicating whether the power incident is a grid power outage or not (e.g., set to 1 if the power incident is a grid power outage, or 0 if the power incident is not a grid power outage). In this way, the incident management application 114 and/or processing entity receiving the incident report 123 may determine that the incident report 123 is related to a power incident caused by a grid power outage (based on the value or text carried in the incident report 123). The next actions taken by the incident management application 114 and/or processing entity with respect to the incident report 123 may be based on the rules 160 as opposed to the standard predefined steps for triaging generic incident reports.

In some embodiments, the incident report 123 may also carry priority data 142 associated with the affected NEs indicated by the affected NE identifiers 256. For example, when the incident report 123 includes an identifier 256 of a cell site 103, the priority data 142 may include data describing a priority associated with the cell site 103. For example, the priority data 142 may include a value (e.g., between 0 to 5 or between 0 to 10) indicating a priority level of the cell site 103. The incident management application 114 may be programmed to perform certain actions based on the value indicated in the priority data 142 in the incident report 123 (e.g., determine period of time to hold the incident report 123 may be based on the priority data 142, whether to simply hold the incident report 123 until the grid power outage is resolved or to extract the incident report 123 from holding to perform a remediation action may be based on the priority data 142, a particular remediation action may be based on the priority data 142, etc.).

In some embodiments, the incident report 123 may carry identifiers 259 of other related NEs that are connected to the affected NEs, receive services from the affected NEs, or are otherwise affected by grid power outages at the affected NEs. For example, when a cell site 103 identified in an identifier 256 is a hub cell site 103 affected by a grid power outage and within a location area of the grid power outage, identifiers 259 of spoke cell sites 103 that are connected to and receive services from the hub cell site 103 may be obtained (e.g., from a data store accessible by the incident management application 114). The identifiers 259 of the spoke cell sites 103 (related NEs) may be added to the incident report 123. The incident management application 114 may be programmed to perform certain actions based on related NE identifiers 259 in the incident report 123 (e.g., verify whether the alarms/incident reports are received from the related NEs, determine a period of time to hold the incident report 123 may be based on the related NE identifiers 259, determine whether to simply hold the incident report 123 until the grid power outage is resolved or to extract the incident report 123 from holding to perform a remediation action may be based on the related NE identifiers 259, determine a particular remediation action may be based on the related NE identifiers 259, etc.).

In an embodiment, the incident reporting application 118 may generate the incident report 123 with the affected NE identifiers 256 and alarm 202 (with other data associated with the alarm 202 and power incident), and then store the incident report 123. In this embodiment, the incident management application 114 may enrich the incident report 123 with the power outage data 145, tag 206, priority data 142, and/or related NE identifiers 259 based on a determination that the incident report 123 is associated with a grid power outage. In another embodiment, the incident reporting application 118 or the incident management application 114 may generate the incident report 123 with the affected NE identifiers 256, alarm 202, power outage data 145, tag 206, priority data 142, and/or related NE identifiers 259 at one time.

Turning now to FIG. 3, a message sequence diagram illustrating a method 300 is shown. Method 300 may be performed by the incident management system shown in FIG. 1, including the incident management application 114 and the incident reporting application 118.

At operation 303, the incident reporting application 118 may obtain an indication of an alarm 202 occurring at a cell site 103 in the RAN 102. The alarm 202 may have been received from the cell site 103, and data associated with the alarm 202 may be stored at the data store 125 upon reception by the incident management system. The incident reporting application 118 may then generate an incident report 123 based on the data associated with the alarm 202 stored at the data store 125. For example, the data associated with the alarm 202 may include the identifiers 256 of the affected cell site 103 (which may include a location of the cell site 103, or may be cross-correlated back to a known location of the cell site 103 associated with the identifier 256), an identification of the alarm 202, and other data describing a state of the cell site 103 and other attributes of the cell site 103 affected by the incident that triggered the alarm 202.

At operation 306, the incident reporting application 118 may transmit the generated incident report 123 to the incident management application 114 (or the incident reporting application 118 may store the incident report 123 at data store 122 or 125, and the incident management application 114 may obtain the incident report 123 from the data store 122 or 125). The incident management application 114 may be programmed to perform various operations based on the rules 160 by first inspecting the incident report 123 to identify the alarm 202 indicated in the incident report 123. At operation 307, the incident management application 114 may use a rule 160 to determine that the alarm 202 is likely to be associated with a grid power outage 309 based on pre-defined associations between different types of alarms 202 and known grid power outages 309 indicated in one or more rules 160.

When the alarm 202 is determined to be likely associated with a grid power outage 309, the incident management application 114 may perform operation 308 to determine whether a location of the cell site 103 is in a location area of the grid power outage 309. In an embodiment, the incident management application 114 may transmit a request to the power monitoring system 119, in which the request includes the identifier 256 and/or location of the cell site 103 identified in the incident report 123. The power monitoring system 119 may be able to use known power outage data to determine whether the cell site 103 identified/located in the request is in a location area of a grid power outage 309. If so, the power monitoring system 119 may transmit back a response with power outage data 145 associated with an identified grid power outage 309 affecting the cell site 103, in which the power outage data 145 includes the location data 148 (identifying the boundaries/region of the location area) and the estimated restoration time 151. From the response received from the power monitoring system 119, the incident management application 114 may perform operation 310 to obtain the estimated restoration time 151 of the grid power outage 309 at the cell site 103.

At operation 312, the incident management application 114 may determine to temporarily store/hold the incident report 123 at the data store 122. Prior to storing the incident report 123 at the data store 122, the incident management application 114 may enrich the incident report 123 to include additional data, such as the power outage data 145 received from the power monitoring system 119, priority data 142 associated with the cell site 103 (obtained from the data store 125), identifiers 259 of related NEs associated with the cell site 103 (obtained from the data store 125 or another data store accessible by the incident management application 114), etc. The incident management application 114 may then determine a period of time 313 to hold the incident report 123 at the data store 122, and this may be based on various factors, a first factor being based on whether the cell site 103 indicated in the incident report 123 has a backup power source 104 or not.

At operation 315, the incident management application 114 may determine that the cell site 103 does not have a backup power source 104, and therefore, the cell site 103 is currently experiencing a grid power outage 309 and a complete loss of power (e.g., completely out of service and not functioning). Based on this determination and a rule 160, the incident management application 114 may perform operation 318 to determine the period of time 313 to hold the incident report 123 at the data store 122. For example, a rule 160 may indicate that when a cell site 103 (or NE) does not include a backup power source 104, the incident management application 114 may determine the period of time 313 based on at least one of the estimated restoration time 151, a predefined default period of time for the NE, power equipment data 139 indicating whether the cell site 103 is capable of using backup power sources 104, power equipment availability data 157 indicating whether backup power sources are available to ship to the cell site 103, priority data 142 indicating whether the other NEs rely on the functionality of the cell site 103, customer impact data 144 indicating a customer impact due to the power incident at the cell site 103, historical data 154 indicating prior power restoration times for the cell site 103, etc.

For example, the incident management application 114 may determine the period of time 313 to hold the incident report 123 to be the entire estimated restoration time 151, and this determination may be based on the estimated restoration time 151 being reasonable (e.g., a relatively short duration) in view of the low priority of the cell site 103 and the low customer impact of the cell site 103 being down. In this case, the incident management application 114 may automatically close the incident report 123 once confirmation is received from the power monitoring system 119 that power has been restored to the cell site 103. As another example, the incident management application 114 may determine the period of time 313 to hold the incident report 123 to be a relatively short duration (e.g., 10 minutes, 5 minutes, 0 minutes), and this determination may be based on the estimated restoration time 151 being unreasonable (e.g., a relatively long duration) in view of the high priority of the cell site 103 and/or the high customer impact of the cell site 103 being down.

The incident management application 114 may wait the determined period of 313 and hold the incident report 123 for the period of time 313. At operation 321, after the period of time 313 has expired, the incident management application 114 may obtain the incident report 123 from the data store 122 (and in some cases, resolve/close the incident report 123 from the data store 122, set values in the incident report 123 to indicate whether the incident report 123 has been reviewed). The incident management application 114 may then determine, based on a rule 160, a remediation action 323 for the cell site 103. The determined remediation action 323 may be based on, for example, priority data 142 indicating a priority of the cell site 103 relative to other NEs and/or the customer impact data 144 indicating an impact of the grid power outage 309 at the cell site 103 on the services provided to customers. For example, the remediation action 323 may include communicating with the power monitoring system 119 to obtain an update of the estimated restoration time 151, and determining whether to hold the incident report 123 for longer or perform another remediation action 323. Additionally or alternatively, the remediation action 323 may involve sending a battery to the cell site 103 when the power equipment data 139 of the cell site 103 indicates that the cell site 103 is capable of being powered with a battery/has a battery with less than the minimum threshold battery capacity. Additionally or alternatively, the remediation action 323 may involve sending a generator and/or sending fuel for the generator to the cell site 103 when the power equipment data 139 of the cell site 103 indicates that the cell site 103 is capable of using a generator/has a generator with less than the minimum threshold generator capacity.

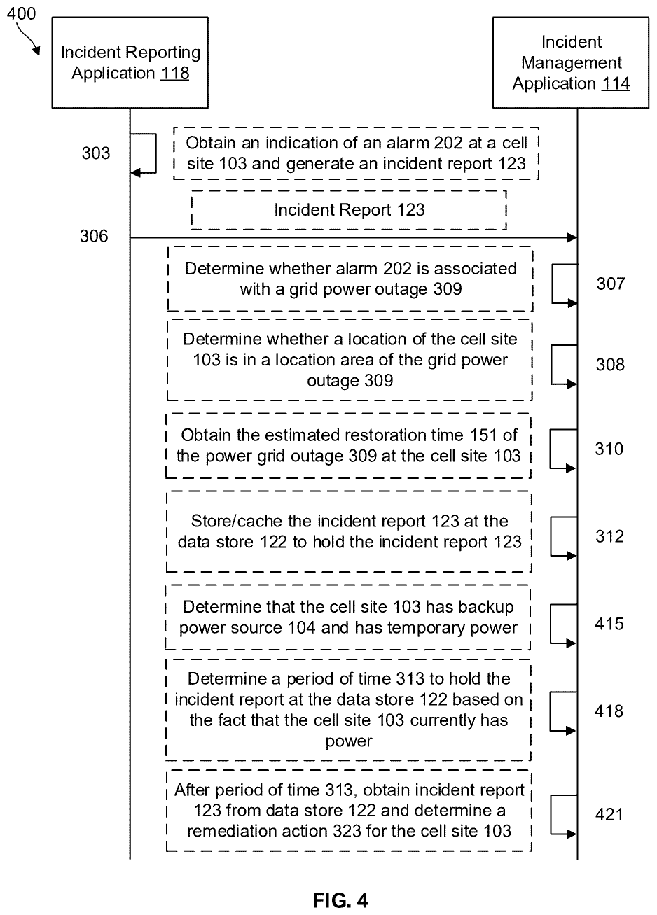

Turning now to FIG. 4, a message sequence diagram illustrating a method 400 is shown. Method 400 may be performed by the incident management application 114 and the incident reporting application 118 of the incident management system described with reference to FIG. 1.

Method 400 includes operations 303, 306, 307, 308, 310, and 312, which are similar to those described above with reference to method 300 of FIG. 3. Therefore, method 400 also involves determining that an incident report 123 is based on a grid power outage 309, receiving power outage data 145 related to the grid power outage 309, and determining to store/hold the incident report 123 at the data store 122 for a period of time 313. However, in method 400, the incident management application 114 may make the determination of the period of time 313 to hold the incident report 123 differently because, unlike in method 300, here the cell site 103 may indeed include a backup power source 104 (e.g., a battery and/or a generator). The backup power source 104 may have an estimated backup power source capacity (e.g., estimated power remaining in the backup power source 104) greater than or equal to a minimum threshold, to provide power to the cell site 103 for at least a predefined period of time (which may be indicated in the data store 125).

In this case, after operation 312, the incident management application 114 may perform operation 415 to determine that the cell site 103 includes a backup power source 104 with a minimum estimated capacity, or at least a predefined amount of power remaining. Based on this determination and a rule 160, the incident management application 114 may perform operation 418 to determine the period of time 313 to hold the incident report 123 at the data store 122. For example, a rule 160 may indicate that when a cell site 103 (or NE) includes a backup power source 104, the incident management application 114 may determine the period of time 313 based on a comparison between the estimated restoration time 151 and an estimated capacity of the backup power source 104 (e.g., an amount of time the cell site 103 is capable of operating before the backup power source 104 is depleted of power). The estimated capacity of the backup power source 104 may be received from the cell site 103 (e.g., over a channel untouched by the power failure), or may be based on telemetry data associated with the backup power source 104 (e.g., stored in the historical data 154, indicating historical rate of power depletion at the backup power source 104, based on various metrics, such as, coverage area, number of customers serviced, functioning radio equipment, equipment manufacturer or vendor etc.).

The incident management application 114 may be programmed with a rule 160 defining the period of time 313 to hold the incident report 123 to be at least a predefined threshold amount of time less than the estimated capacity of the backup power source 104 when the estimated restoration time 151 is greater than the estimated capacity of the backup power source 104. For example, suppose the estimated restoration time 151 received from the power monitoring system 119 is 8 hours, but the estimated capacity of the backup power source 104 is 4 hours. The rule 160 may instruct the incident management application 114 to hold the incident report 123 for a period of time 313 of 2 hours (e.g., the predefined threshold period of time (2 hours) less than the estimated capacity of the backup power source 104 (4 hours)). In some cases, the determined period of time 313 may additionally or alternatively based on at least one of the estimated restoration time 151, a predefined default period of time for the cell site 103, power equipment data 139 indicating whether the cell site 103 is capable of using backup power sources 104, power equipment availability data 157 indicating whether backup power sources are available to ship to the cell site 103, priority data 142 indicating whether the other NEs rely on the functionality of the cell site 103, customer impact data 144 indicating a customer impact due to the power incident at the cell site 103, historical data 154 indicating prior power restoration times for the cell site 103, etc.

The incident management application 114 may wait the determined period of 313 and hold the incident report 123 for the period of time 313. At operation 421, after the period of time 313 has expired, the incident management application 114 may obtain the incident report 123 from the data store 122 (and in some cases, close or resolve the incident report 123 from the data store 122). The incident management application 114 may then determine, based on a rule 160, a remediation action 323 for the cell site 103. The determined remediation action 323 may be based on, for example, radio equipment data 136 describing the radio equipment and functions active at the cell site 103, priority data 142 indicating a priority of the cell site 103 relative to other NEs and/or the customer impact data 144 indicating an impact of the grid power outage 309 at the cell site 103 on the services provided to customers.

As described above, the remediation action 323 may include receiving an update of the estimated restoration time 151 from the power monitoring system 113, and/or instructing a battery/generator/fuel to be shipped to the cell site 103 for installation at the cell site 103 to at least temporarily restore power to the cell site 103. In this case, since there is currently power at the cell site 103, another remediation action 323 may be available, which may involve performing power mitigation across the radio equipment at the cell site 103 based on the radio equipment data 136 to conserve power at the cell site 103 until grid power is restored. The incident management application 114 may transmit instructions to the cell site 103 to throttle or stop data transmissions using one radio/antenna at the cell site, such that power may be reserved for data transmissions using other, more prioritized, customer impacting radio equipment at the cell site 103. For example, incident management application 114 may transmit instructions to the cell site 103 to systematically turn down radio equipment operating on infrequently used spectrums (e.g., GSM) or other radio technologies to increase battery life, while ensuring the other radio equipment operating on higher priority spectrums (e.g., 2.5 GHz spectrums). The priority level of the radio equipment at the cell site 103 may be indicated in the radio equipment data 136 such that the incident management application 114 may intelligently tune down only the lower priority radio equipment (while retaining all functions of the higher priority radio equipment) to conserve power at the cell site 103 while waiting the estimated restoration time 151 for the power company to restore power at the cell site 103.

In some cases, the holding of the incident report 123 and/or remediation actions 323 may change as updates to the estimated restoration times 151 are received from the power monitoring system 119. For example, suppose the incident management application 114 initially determined to hold the incident report 123 until the power company restores power to the cell site 103. However, a subsequent update to the estimated restoration time 151 received from the power monitoring system 119 indicates that the updated estimated restoration time 151 has increased considerably and is no longer reasonable in view of the data associated with the affected cell site 103 (e.g., the priority data 142 and/or customer impact data 144). In this case, the incident management application 114 may perform operations 321 or 421 to retrieve the incident report 123, thereby stopping the hold on the incident report 123, and instead determine a remediation action 323 to perform in an attempt to provide power to the cell site 103.

Referring now to FIG. 5, shown is a diagram 500 illustrating a hub-and-spoke architecture of multiple cell sites 103 in the RAN 102, in which a first cell site 503 is a hub cell site, and four other cell sites 506A, 506B, 506C, and 506D are spoke cell sites. The hub cell site 503 may provide backhaul services to the spoke cell sites 506A-D via the network 106, and therefore the hub cell site 503 may have a higher priority than the spoke cell sites 506A-D because the hub cell site 503 provides services to other cell sites 506A-D. The priority data 142 of the hub cell site 503 may indicate a value representing the high priority of the hub cell site 503, and may also include identifiers 259 of the spoke cell sites 509A-D depending on the hub cell site 503.

As shown in FIG. 5, suppose a grid power outage 309 occurs in a location area (as indicated in location data 148) only covering the hub cell site 503 (i.e., not affecting spoke cell sites 506A-D). In this case, the incident reporting application 118 may receive/obtain from storage alarms 202A, 202B, 202C, 202D, and 202E. Alarms 202A-D (e.g., transport alarms) may be received from spoke cell sites 506A-D, respectively, because the spoke cell sites 506A-D may not be reachable or may not be capable of performing data communications. This may be due to the fact that the hub cell site 503, which again provides essential functions to the spoke cell sites 506A-D, is experiencing the grid power outage 309, resulting in a complete outage at the hub cell site 503. Therefore, alarms 202A-D are received from spoke cell sites 506A-D even though the spoke cell sites 506A-D are not experiencing the grid power outage 309. Meanwhile, the alarm 202E (e.g., transport alarm and/or power alarm) received from the hub cell site 503 may be based on the loss of grid power at the hub cell site 503. In this example, the hub cell site 503 may not have a backup power source 104, and therefore, is not capable of providing services to the spoke cell sites 506A-D.

The incident reporting application 118 may generate different incident reports 123A-E for each of the alarms 202A-E, respectively, and store the incident reports 123A-E or transmit the incident reports 123A-E to the incident management application 114. The incident management application 114 may determine, based on the priority data 142 stored in the RAN equipment data 130 at the data store 125, that hub cell site 503 indicated in incident report 123E is related to the spoke cell sites 506A-D indicated in incident reports 123A-D, and thus the incidents described in each of these incident reports 123A-E are related. This determination may be further based on the timing of the alarms 202A-E (e.g., all alarms 202A-E were received within a common time window). The incident management application 114 may also determine, based on the priority data 152, that the hub cell site 503 has a higher priority than the spoke cell sites 506A-D. Based on this, the incident management application 114 may determine that the alarms 202A-D received from spoke cell sites 506A-D are caused by the incident at the hub cell site 503. The incident management application 114 may then determine, as described above in methods 300 and 400, whether the incident occurring at the hub cell site 503 is a grid power outage 309. If so, the incident management application 114 may enrich the incident reports 123A-D of spoke cell sites 506A-D to include the related NE identifier 259 of the hub cell site 503. The incident report 123E of the hub cell site 503 may include the affected NE identifier 256 of the hub cell site 503, and related NE identifiers 259 of the spoke cell sites 506A-D.

In this way, the incident reports 123A-E may be grouped together as being associated with the same power incident occurring at the hub cell site 503. The incident management application 114 may perform the methods 300 and 400 with respect to all of the incident reports 123A-E to address the incidents occurring at all of the cell sites 503 and 506A-D. In an embodiment, incident management application 114 may aggregate the incident reports 123A-E into a single incident report 123, identifying the hub cell site 503 as the one experiencing the grid power outage 309 and the spoke cell sites 506A-D as being affected by the outage at the hub cell site 503 but experiencing the grid power outage 309. This aggregated incident report 123 may also include the data described above with reference to FIG. 2 (e.g., the power outage data 145, tag 206, etc.)

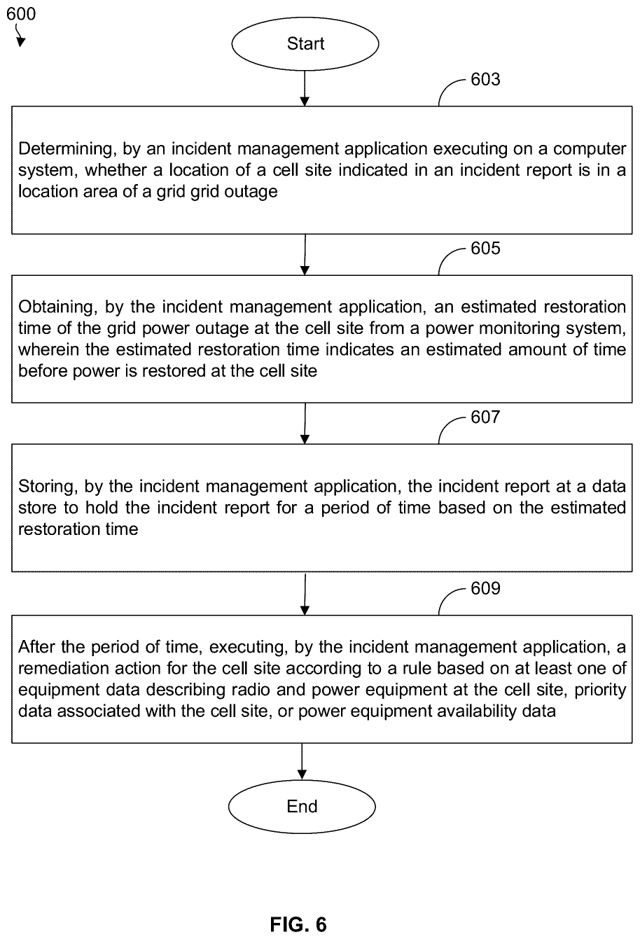

Turning now to FIG. 6, a method 600 is described. Method 600 may be performed by the incident management application 114 and/or the incident reporting application 118 of the communication network 100. Method 600 may be performed based on the data stored in the data store 125. As illustrated, method 600 of FIG. 6 includes a number of enumerated operations, but embodiments of the operations in FIG. 6 may include additional operations before, after, and in between the enumerated operations. In some embodiments, one or more of the enumerated operations may be omitted or performed in a different order.

At step 603, method 600 comprises determining, by an incident management application 114 executing on a computer system, whether a location of a cell site 103 indicated in an incident report 123 is in a location area of a grid power outage 309. The location area of the grid power outage 309 may be indicated in location data 148 in the power outage data 145. At step 605, method 600 comprises obtaining, by the incident management application 114, an estimated restoration time 151 of the grid power outage 309 at the cell site 103 from a power monitoring system 119. The estimated restoration time 151 indicates an estimated amount of time before power is restored at the cell site 103 (e.g., by a power company). At step 607, method 600 comprises storing, by the incident management application 114, the incident report 123 at a data store 122 to hold the incident report 123 for a period of time 313 based on the estimated restoration time 151. At step 609, method 600 comprises, after the period of time 313, executing, by the incident management application 114, a remediation action 323 for the cell site 103 according to a rule 160 based on at least one of equipment data describing radio and power equipment at the cell site 103 (e.g., radio equipment data 136 and power equipment data 139), priority data 142 associated with the cell site 103, or power equipment availability data 157.

Method 600 may comprise other attributes and steps not otherwise shown in the flowchart of FIG. 6. In an embodiment, method 600 may further comprise determining, by the incident management application 114, the period of time 313 based further on the equipment data indicating whether a backup power source 104 is available at the cell site 103 and telemetry data (e.g., in the historical data 154) indicating an estimated capacity of the backup power source 104, the priority data 142 indicating a priority of the cell site 103, or a customer impact of the grid power outage 309 (e.g., indicated in the customer impact data 144).

In an embodiment, the remediation action 323 comprises at least one of contacting, by the incident management application 114, a power company associated with the grid power outage or the power monitoring system 119 to retrieve an updated estimated restoration time 151, implementing, by the incident management application 114, power mitigation across one or more radio equipment at the cell site 103 to preserve battery power at the cell site 103, or transmitting, by the incident management application 114, an instruction to a network operations center operator to dispatch additional fuel for a generator at the cell site 103 or to dispatch a new battery to the cell site 103.

In an embodiment, method 600 may further comprise adding, by the incident management application 114, power outage data 145 to the incident report 123 based on a second rule 160 before storing the incident report 123 in the data store 122. The power outage data 145 includes location data 148 describing the location area of the grid power outage 309 and the estimated restoration time 151. The second rule 160 instructs that, when the incident report 123 indicates the alarm 202, the incident management application 114 is to determine whether the location of the cell site 103 indicated in the incident report 123 is in the location area of the grid power outage 309.

In an embodiment, when the cell site 103 includes a backup power source 104, the period of time 313 to hold the incident report 123 is based on at least one of the estimated restoration time 151 and an estimated capacity of the backup power source 104. In an embodiment, when the cell site 103 does not include a backup power source 104, the period of time 313 to hold the incident report 123 is based on at least one of the estimated restoration time 151, the priority data 142 associated with the cell site 103, and the power equipment availability data 157.

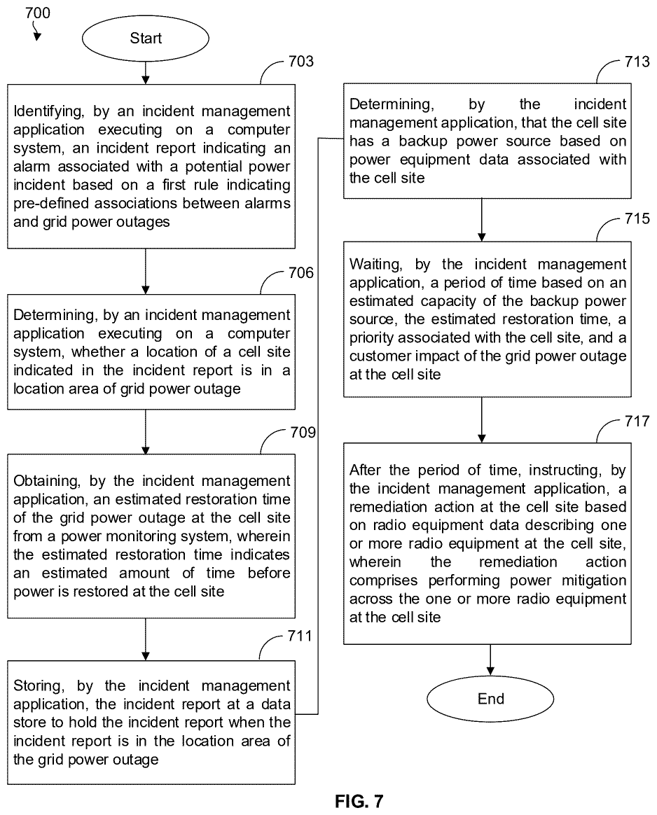

Turning now to FIG. 7, a method 700 for power outage-based incident report triage and remediation is described. Method 700 may be performed by the incident management application 114 and/or the incident reporting application 118 of the communication network 100. Method 700 may be performed based on the data stored in the data store 125. As illustrated, method 700 of FIG. 7 includes a number of enumerated operations, but embodiments of the operations in FIG. 7 may include additional operations before, after, and in between the enumerated operations. In some embodiments, one or more of the enumerated operations may be omitted or performed in a different order.

At step 703, method 700 comprises identifying, by an incident management application 114 executing on a computer system, an incident report 123 indicating an alarm 202 associated with a potential power incident based on a first rule 160 indicating pre-defined associations between alarms 202 and grid power outages. At step 706, method 700 comprises determining, by the incident management application 114, whether a location of a cell site 103 indicated in the incident report 123 is in a location area of grid power outage 309.

At step 709, method 700 comprises obtaining, by the incident management application 114, an estimated restoration time 151 of the grid power outage 309 at the cell site 103 from a power monitoring system 119. The estimated restoration time 151 indicates an estimated amount of time before power is restored at the cell site 103. At step 711, method 700 comprises storing, by the incident management application 114, the incident report 123 at a data store 122 to hold the incident report 123 when the incident report 123 is in the location area of the grid power outage 309. At step 713, method 700 comprises determining, by the incident management application 114, that the cell site 103 has a backup power source 104 based on power equipment data 139 associated with the cell site 103.

At step 715, method 700 comprises waiting, by the incident management application 114, a period of time 313 based on an estimated capacity of the backup power source 104, the estimated restoration time 151, a priority associated with the cell site 103, and a customer impact of the grid power outage 309 at the cell site 103. At step 717, method 700 comprises, after the period of time 313, instructing, by the incident management application 114, a remediation action 323 at the cell site 103 based on radio equipment data 136 describing one or more radio equipment at the cell site 103. The remediation action 323 comprises performing power mitigation across the one or more radio equipment at the cell site 103.

Method 700 may comprise other attributes and steps not otherwise shown in the flowchart of FIG. 7. In an embodiment, method 700 may further comprise adding, by the incident management application 114, power outage data 145 describing the grid power outage 309 and the estimated restoration time 151 to the incident report 123. In an embodiment, determining whether the location of the cell site 103 indicated in the incident report 123 is in the location area of the grid power outage 309 and obtaining the estimated restoration time 151 comprises, transmitting, by the incident management application 114, a request to the power monitoring system 119, wherein the request includes the location of the cell site 103 indicated in the incident report 123, and receiving, by the incident management application 114, a response from the power monitoring system 119, wherein the response indicates whether the location of the cell site is in the location area of a grid power outage 309 and indicates the estimated restoration time 151.

In an embodiment, the backup power source 104 is a battery, and the estimated capacity of the backup power source is an estimated battery life of the battery indicating an amount of time the cell site 103 is capable of operating before the battery is depleted. In an embodiment, the backup power source 104 is a generator, and the estimated capacity of the backup power source 104 is an estimated runtime of the generator indicating an amount of time the cell site 103 is capable of operating before the generator is depleted of fuel. In an embodiment, the estimated capacity of the backup power source 104 indicates an amount of time the cell site 103 is capable of operating before the backup power source 104 is depleted of power, and the period of time 313 is less than the estimated capacity of the backup power source 104 by at least a threshold time.

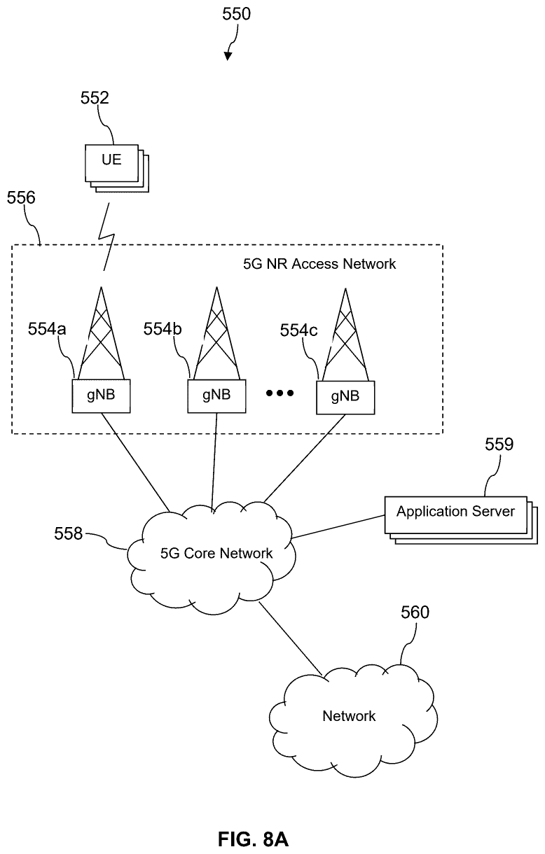

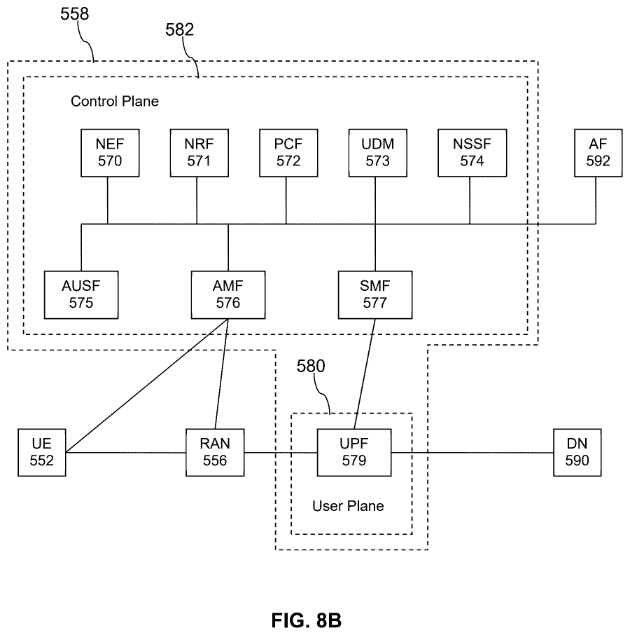

Turning now to FIG. 8A, an exemplary communication system 550 is described, similar to the communication network 100. Typically, the communication system 550 includes a number of access nodes 554 that are configured to provide coverage in which UEs 552 such as cell phones, tablet computers, machine-type-communication devices, tracking devices, embedded wireless modules, and/or other wirelessly equipped communication devices (whether or not user operated), can operate. The access nodes 554 may be said to establish an access network 556. The access network 556 may be referred to as a radio access network (RAN) in some contexts. In a 5G technology generation an access node 554 may be referred to as a next Generation Node B (gNB). In 4G technology (e.g., long term evolution (LTE) technology) an access node 554 may be referred to as an evolved Node B (eNB). In 3G technology (e.g., code division multiple access (CDMA) and global system for mobile communication (GSM)) an access node 554 may be referred to as a base transceiver station (BTS) combined with a base station controller (BSC). In some contexts, the access node 554 may be referred to as a cell site or a cell tower. In some implementations, a picocell may provide some of the functionality of an access node 554, albeit with a constrained coverage area. Each of these different embodiments of an access node 554 may be considered to provide roughly similar functions in the different technology generations.

In an embodiment, the access network 556 comprises a first access node 554a, a second access node 554b, and a third access node 554c. It is understood that the access network 556 may include any number of access nodes 554. Further, each access node 554 could be coupled with a core network 558 that provides connectivity with various application servers 559 and/or a network 560. In an embodiment, at least some of the application servers 559 may be located close to the network edge (e.g., geographically close to the UE 552 and the end user) to deliver so-called “edge computing.” The network 560 may be one or more private networks, one or more public networks, or a combination thereof. The network 560 may comprise the public switched telephone network (PSTN). The network 560 may comprise the Internet. With this arrangement, a UE 552 within coverage of the access network 556 could engage in air-interface communication with an access node 554 and could thereby communicate via the access node 554 with various application servers and other entities.

The communication system 550 could operate in accordance with a particular radio access technology (RAT), with communications from an access node 554 to UEs 552 defining a downlink or forward link and communications from the UEs 552 to the access node 554 defining an uplink or reverse link. Over the years, the industry has developed various generations of RATs, in a continuous effort to increase available data rate and quality of service for end users. These generations have ranged from “1G,” which used simple analog frequency modulation to facilitate basic voice-call service, to “4G”—such as Long Term Evolution (LTE), which now facilitates mobile broadband service using technologies such as orthogonal frequency division multiplexing (OFDM) and multiple input multiple output (MIMO).

Recently, the industry has been exploring developments in “5G” and particularly “5G NR” (5G New Radio), which may use a scalable OFDM air interface, advanced channel coding, massive MIMO, beamforming, mobile mmWave (e.g., frequency bands above 24 GHz), and/or other features, to support higher data rates and countless applications, such as mission-critical services, enhanced mobile broadband, and massive Internet of Things (IoT). 5G is hoped to provide virtually unlimited bandwidth on demand, for example providing access on demand to as much as 20 gigabits per second (Gbps) downlink data throughput and as much as 10 Gbps uplink data throughput. Due to the increased bandwidth associated with 5G, it is expected that the new networks will serve, in addition to conventional cell phones, general internet service providers for laptops and desktop computers, competing with existing ISPs such as cable internet, and also will make possible new applications in internet of things (IoT) and machine to machine areas.

In accordance with the RAT, each access node 554 could provide service on one or more radio-frequency (RF) carriers, each of which could be frequency division duplex (FDD), with separate frequency channels for downlink and uplink communication, or time division duplex (TDD), with a single frequency channel multiplexed over time between downlink and uplink use. Each such frequency channel could be defined as a specific range of frequency (e.g., in radio-frequency (RF) spectrum) having a bandwidth and a center frequency and thus extending from a low-end frequency to a high-end frequency. Further, on the downlink and uplink channels, the coverage of each access node 554 could define an air interface configured in a specific manner to define physical resources for carrying information wirelessly between the access node 554 and UEs 552.

Without limitation, for instance, the air interface could be divided over time into frames, subframes, and symbol time segments, and over frequency into subcarriers that could be modulated to carry data. The example air interface could thus define an array of time-frequency resource elements each being at a respective symbol time segment and subcarrier, and the subcarrier of each resource element could be modulated to carry data. Further, in each subframe or other transmission time interval (TTI), the resource elements on the downlink and uplink could be grouped to define physical resource blocks (PRBs) that the access node could allocate as needed to carry data between the access node and served UEs 552.

In addition, certain resource elements on the example air interface could be reserved for special purposes. For instance, on the downlink, certain resource elements could be reserved to carry synchronization signals that UEs 552 could detect as an indication of the presence of coverage and to establish frame timing, other resource elements could be reserved to carry a reference signal that UEs 552 could measure in order to determine coverage strength, and still other resource elements could be reserved to carry other control signaling such as PRB-scheduling directives and acknowledgement messaging from the access node 554 to served UEs 552. And on the uplink, certain resource elements could be reserved to carry random access signaling from UEs 552 to the access node 554, and other resource elements could be reserved to carry other control signaling such as PRB-scheduling requests and acknowledgement signaling from UEs 552 to the access node 554.

The access node 554, in some instances, may be split functionally into a radio unit (RU), a distributed unit (DU), and a central unit (CU) where each of the RU, DU, and CU have distinctive roles to play in the access network 556. The RU provides radio functions. The DU provides L1 and L2 real-time scheduling functions; and the CU provides higher L2 and L3 non-real time scheduling. This split supports flexibility in deploying the DU and CU. The CU may be hosted in a regional cloud data center. The DU may be co-located with the RU, or the DU may be hosted in an edge cloud data center.

Turning now to FIG. 8B, further details of the core network 558 are described. In an embodiment, the core network 558 is a 5G core network. 5G core network technology is based on a service based architecture paradigm. Rather than constructing the 5G core network as a series of special purpose communication nodes (e.g., an HSS node, a MME node, etc.) running on dedicated server computers, the 5G core network is provided as a set of services or network functions. These services or network functions can be executed on virtual servers in a cloud computing environment which supports dynamic scaling and avoidance of long-term capital expenditures (fees for use may substitute for capital expenditures). These network functions can include, for example, a user plane function (UPF) 579, an authentication server function (AUSF) 575, an access and mobility management function (AMF) 576, a session management function (SMF) 577, a network exposure function (NEF) 570, a network repository function (NRF) 571, a policy control function (PCF) 572, a unified data management (UDM) 573, a network slice selection function (NSSF) 574, and other network functions. The network functions may be referred to as virtual network functions (VNFs) in some contexts.

Network functions may be formed by a combination of small pieces of software called microservices. Some microservices can be re-used in composing different network functions, thereby leveraging the utility of such microservices. Network functions may offer services to other network functions by extending application programming interfaces (APIs) to those other network functions that call their services via the APIs. The 5G core network 558 may be segregated into a user plane 580 and a control plane 582, thereby promoting independent scalability, evolution, and flexible deployment.

The UPF 579 delivers packet processing and links the UE 552, via the access network 556, to a data network 590 (e.g., the network 560 illustrated in FIG. 8A). The AMF 576 handles registration and connection management of non-access stratum (NAS) signaling with the UE 552. Said in other words, the AMF 576 manages UE registration and mobility issues. The AMF 576 manages reachability of the UEs 552 as well as various security issues. The SMF 577 handles session management issues. Specifically, the SMF 577 creates, updates, and removes (destroys) protocol data unit (PDU) sessions and manages the session context within the UPF 579. The SMF 577 decouples other control plane functions from user plane functions by performing dynamic host configuration protocol (DHCP) functions and IP address management functions. The AUSF 575 facilitates security processes.

The NEF 570 securely exposes the services and capabilities provided by network functions. The NRF 571 supports service registration by network functions and discovery of network functions by other network functions. The PCF 572 supports policy control decisions and flow based charging control. The UDM 573 manages network user data and can be paired with a user data repository (UDR) that stores user data such as customer profile information, customer authentication number, and encryption keys for the information. An application function 592, which may be located outside of the core network 558, exposes the application layer for interacting with the core network 558. In an embodiment, the application function 592 may be executed on an application server 559 located geographically proximate to the UE 552 in an “edge computing” deployment mode. The core network 558 can provide a network slice to a subscriber, for example an enterprise customer, that is composed of a plurality of 5G network functions that are configured to provide customized communication service for that subscriber, for example to provide communication service in accordance with communication policies defined by the customer. The NSSF 574 can help the AMF 576 to select the network slice instance (NSI) for use with the UE 552.

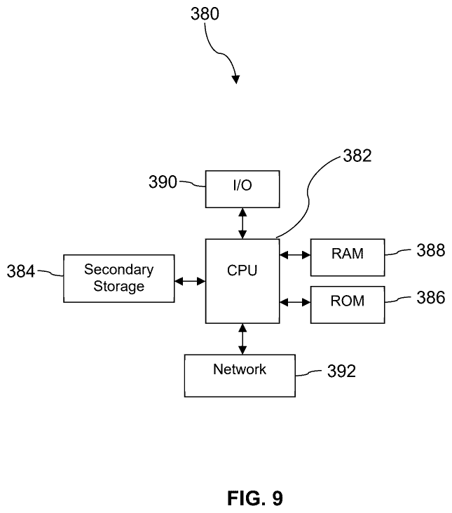

FIG. 9 illustrates a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC) and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method for power outage-based incident report triage and remediation, comprising:
identifying, by an incident management application executing on a computer system, an incident report indicating an alarm associated with a potential power incident based on a first rule indicating pre-defined associations between alarms and grid power outages;
determining, by the incident management application, whether a location of a cell site indicated in the incident report is in a location area of grid power outage;
obtaining, by the incident management application, an estimated restoration time of the grid power outage at the cell site from a power monitoring system, wherein the estimated restoration time indicates an estimated amount of time before power is restored at the cell site;
storing, by the incident management application, the incident report at a data store to hold the incident report when the incident report is in the location area of the grid power outage;
determining, by the incident management application, that the cell site has a backup power source based on power equipment data associated with the cell site;
waiting, by the incident management application, a period of time based on an estimated capacity of the backup power source, the estimated restoration time, a priority associated with the cell site, and a customer impact of the grid power outage at the cell site; and
after the period of time, instructing, by the incident management application, a remediation action at the cell site based on radio equipment data describing one or more radio equipment at the cell site, wherein the remediation action comprises performing power mitigation across the one or more radio equipment at the cell site.

2. The method of claim 1, further comprising adding, by the incident management application, power outage data describing the grid power outage and the estimated restoration time to the incident report.

3. The method of claim 1, wherein determining whether the location of the cell site indicated in the incident report is in the location area of the grid power outage and obtaining the estimated restoration time comprises:
transmitting, by the incident management application, a request to the power monitoring system, wherein the request includes the location of the cell site indicated in the incident report; and
receiving, by the incident management application, a response from the power monitoring system, wherein the response indicates whether the location of the cell site is in the location area of a grid power outage and indicates the estimated restoration time.

4. The method of claim 1, wherein the backup power source is a battery, and wherein the estimated capacity of the backup power source is an estimated battery life of the battery indicating an amount of time the cell site is capable of operating before the battery is depleted.

5. The method of claim 1, wherein the backup power source is a generator, and wherein the estimated capacity of the backup power source is an estimated runtime of the generator indicating an amount of time the cell site is capable of operating before the generator is depleted of fuel.

6. The method of claim 1, wherein the estimated capacity of the backup power source indicates an amount of time the cell site is capable of operating before the backup power source is depleted of power, and wherein the period of time is less than the estimated capacity of the backup power source by at least a threshold time.

7. A computer system:
a processor;
an incident management application stored in a non-transitory memory of the computer system, which, when executed by the processor, causes the incident management application to be configured to:
determine whether a location of a network element indicated in an incident report is in a location area of a grid power outage based on power outage data received from a power monitoring system;
obtain an estimated restoration time of the grid power outage at the network element, wherein the estimated restoration time indicates an estimated amount of time before power is restored at the network element;
store the incident report at a data store to hold the incident report; and
when the network element does not have power and does not have a backup power source:
determine a period of time to wait based on the estimated restoration time, priority data associated with the network element, and customer impact data describing a customer impact of the grid power outage at the network element; and
after the period of time, execute a remediation action for restoring power to the network element based on power equipment data associated with the network element, wherein the remediation action includes transmitting an instruction to a maintenance technician or a network operation center operator to dispatch a backup power source to the network element.

8. The computer system of claim 7, wherein the incident management application is further configured to:
transmit a request to the power monitoring system, wherein the request includes a location of the network element indicated in the incident report; and
receive a response from the power monitoring system, wherein the response indicates whether the location of the network element is in the location area of a grid power outage and indicates the estimated restoration time.

9. The computer system of claim 7, wherein the remediation action is based on power equipment data of the network element indicating whether the network element is capable of using a generator or capable of receiving a new battery.

10. The computer system of claim 7, wherein the remediation action further comprises obtaining an updated estimated restoration time of the grid power outage at the network element from the power monitoring system.

11. The computer system of claim 7, wherein the customer impact data indicates the customer impact of the grid power outage at the network element based on at least one of a number of users receiving services provided by the network element during the grid power outage, a time of day of the grid power outage, or other related network elements associated with the network element.

12. The computer system of claim 7, wherein the priority data associated with the network element indicates whether the network element provides services to other network elements, and wherein the network element is assigned a higher priority than the other network elements.

13. The computer system of claim 7, wherein the period of time is at least a default predefined period of time.

14. The computer system of claim 7, wherein the incident report includes a flag indicating that the incident report describes an incident caused by the grid power outage.

15. A method comprising:
determining, by an incident management application executing on a computer system, whether a location of a cell site indicated in an incident report is in a location area of a grid power outage;
obtaining, by the incident management application, an estimated restoration time of the grid power outage at the cell site from a power monitoring system, wherein the estimated restoration time indicates an estimated amount of time before power is restored at the cell site;
storing, by the incident management application, the incident report at a data store to hold the incident report for a period of time based on the estimated restoration time; and
after the period of time, executing, by the incident management application, a remediation action for the cell site according to a rule based on at least one of equipment data describing radio and power equipment at the cell site, priority data associated with the cell site, or power equipment availability data.

16. The method of claim 15, further comprising determining, by the incident management application, the period of time based further on the equipment data indicating whether a backup power source is available at the cell site and telemetry data indicating an estimated capacity of the backup power source, the priority data indicating a priority of the cell site, or a customer impact of the grid power outage.

17. The method of claim 15, wherein the remediation action comprises at least one of:
contacting, by the incident management application, a power company associated with the grid power outage or the power monitoring system to retrieve an updated estimated restoration time;
implementing, by the incident management application, power mitigation across one or more radio equipment at the cell site to preserve battery power at the cell site; or
transmitting, by the incident management application, an instruction to a network operations center operator to dispatch additional fuel for a generator at the cell site or to dispatch a new battery to the cell site.

18. The method of claim 15, further comprising:
adding, by the incident management application, power outage data to the incident report based on a second rule before storing the incident report in the data store, wherein the power outage data includes location data describing the location area of the grid power outage and the estimated restoration time,
wherein the second rule instructs that, when the incident report indicates a predefined alarm, the incident management application is to determine whether the location of the cell site indicated in the incident report is in the location area of the grid power outage.

19. The method of claim 15, wherein, when the cell site includes a backup power source, the period of time to hold the incident report is based on at least one of the estimated restoration time and an estimated capacity of the backup power source.

20. The method of claim 15, wherein, when the cell site does not include a backup power source, the period of time to hold the incident report is based on at least one of the estimated restoration time, the priority data associated with the cell site, and the power equipment availability data.
